(19) United States
(12) Patent Application Publication
(10) Pub. No.: US 2021/0067930 A1
(43) Pub. Date: Mar. 4, 2021

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventors: Tomonori Yokota, Wako-shi (JP); Takumi Nomura, Wako-shi (JP); Toru Nakamura, Wako-shi (JP)

(21) Appl. No.: 17/002,922

(22) Filed: Aug. 26, 2020

(30) Foreign Application Priority Data
Aug. 30, 2019 (JP) 2019-157892

(51) Int. Cl. H04W 4/48; H04L 12/40

(52) U.S. Cl. CPC H04W 4/48; H04L 2012/40273; H04L 2012/40215; H04L 12/40

(57) ABSTRACT

A vehicle control system includes a first controller mounted in a vehicle and a plurality of second controllers mounted in the vehicle, each of the plurality of second controllers being configured to control at least one in-vehicle device allocated to the second controller among a plurality of in-vehicle devices mounted in the vehicle, wherein the first controller is configured to perform communication with each of the plurality of second controllers via a first type network, the communication regarding an operation of the second controller, and at least the plurality of second controllers are configured to be able to communicate with each other via a second type network different from the first type network.

### CROSS-REFERENCE TO RELATED APPLICATION

Priority is claimed on Japanese Patent Application No. 2019-157892, filed Aug. 30, 2019, the content of which is incorporated herein by reference.

### BACKGROUND OF THE INVENTION

### Field of the Invention

The present invention relates to a vehicle control system, a vehicle control method, and a storage medium.

### Description of Related Art

In the related art, a technology in which electronic control units (ECUs) for mounting in a vehicle are provided in the vehicle in predetermined areas and a main ECU controls a plurality of ECUs provided in predetermined areas has been disclosed (for example, Japanese Unexamined Patent Application, First Publication No. 2019-031120).

### SUMMARY OF THE INVENTION

However, in the technology of the related art, when a network between the plurality of ECUs and the main ECU becomes incommunicable, it is difficult for the main ECU to communicate with other ECUs.

Aspects according to the present invention have been made in view of such circumstances and it is an object of the present invention to provide a vehicle control system, a vehicle control method, and a storage medium which can achieve redundancy of communication between controllers of a vehicle while limiting cost increases.

The present invention adopts the following aspects to solve the above problems and achieve the object.

(1) An aspect of the present invention provides a vehicle control system including a first controller mounted in a vehicle and a plurality of second controllers mounted in the vehicle, each of the plurality of second controllers being configured to control at least one in-vehicle device allocated to the second controller among a plurality of in-vehicle devices mounted in the vehicle, wherein the first controller is configured to perform communication with each of the plurality of second controllers via a first type network, the communication regarding an operation of the second controller, and at least the plurality of second controllers are configured to be able to communicate with each other via a second type network different from the first type network.

(2) In the vehicle control system according to the above aspect (1), the first type network may have a higher payload transmission efficiency than the second type network.

(3) In the vehicle control system according to the above aspect (1) or (2), the first controller may be configured to, when a first type network between the first controller and a specific one of the plurality of second controllers has reached a predetermined state, communicate with a second controller other than the specific second controller via a first type network and communicate with the specific second controller via the second controller other than the specific second controller.

(4) In the vehicle control system according to any one of the above aspects (1) to (3), the first controller may be configured to be also connectable to the second type network and, when the first type network has reached a predetermined state, communicate with the second controller connected to the first type network that has reached the predetermined state via the second type network.

(5) In the vehicle control system according to any one of the above aspects (1) to (4), at least one of the first controller and the second controllers may be configured to, when the first type network has reached a predetermined state, perform simpler control than that before the first type network reached the predetermined state.

(6) In the vehicle control system according to any one of the above aspects (1) to (5), the first type network and the second type network may be networks of different communication protocols.

(7) In the vehicle control system according to any one of the above aspects (1) to (6), wherein the first type network may be an Ethernet-based network and the second type network may be a controller area network (CAN)-based network.

(8) An aspect of the present invention provides a vehicle control method for a computer including a first controller mounted in a vehicle and a plurality of second controllers mounted in the vehicle, each of the plurality of second controllers being configured to control at least one in-vehicle device allocated to the second controller among a plurality of in-vehicle devices mounted in the vehicle, the vehicle control method including the computer causing the first controller to perform communication with each of the plurality of second controllers via a first type network, the communication regarding an operation of the second controller, and causing at least the plurality of second controllers to be able to communicate with each other via a second type network different from the first type network.

(9) An aspect of the present invention provides a computer-readable non-temporary storage medium storing a program for a computer including a first controller mounted in a vehicle and a plurality of second controllers mounted in the vehicle, each of the plurality of second controllers being configured to control at least one in-vehicle device allocated to the second controller among a plurality of in-vehicle devices mounted in the vehicle, the program allowing the computer to cause the first controller to perform communication with each of the plurality of second controllers via a first type network, the communication regarding an operation of the second controller, and cause at least the plurality of second controllers to be able to communicate with each other via a second type network different from the first type network.

According to the above aspects (1) to (9), it is possible to achieve redundancy of communication between the controllers of the vehicle while limiting cost increases.

### BRIEF DESCRIPTION OF THE DRAWINGS

FIG. 1 is a diagram showing an example of a configuration of a vehicle control system.

FIG. 2 is a diagram showing an example of a network configuration of the vehicle control system.

FIG. 3 is a diagram showing an example of a configuration of each second controller.

FIG. 4 is a diagram showing an example of a configuration of a first controller.

FIG. 5 is a diagram schematically showing communication between the first controller and a second controller.

FIG. 6 is a diagram schematically showing communication between the first controller and a second controller when an Ethernet therebetween has failed according to an embodiment.

FIG. 7 is a flowchart showing an example of processing of a communication controller of the first controller and a communication controller of the second controller.

FIG. 8 is a diagram schematically showing communication between the first controller and a second controller when an Ethernet therebetween has failed according to a modification.

### DETAILED DESCRIPTION OF THE INVENTION

Embodiments of a vehicle control system, a vehicle control method, and a storage medium of the present invention will be described below with reference to the drawings.

### [Overall Configuration]

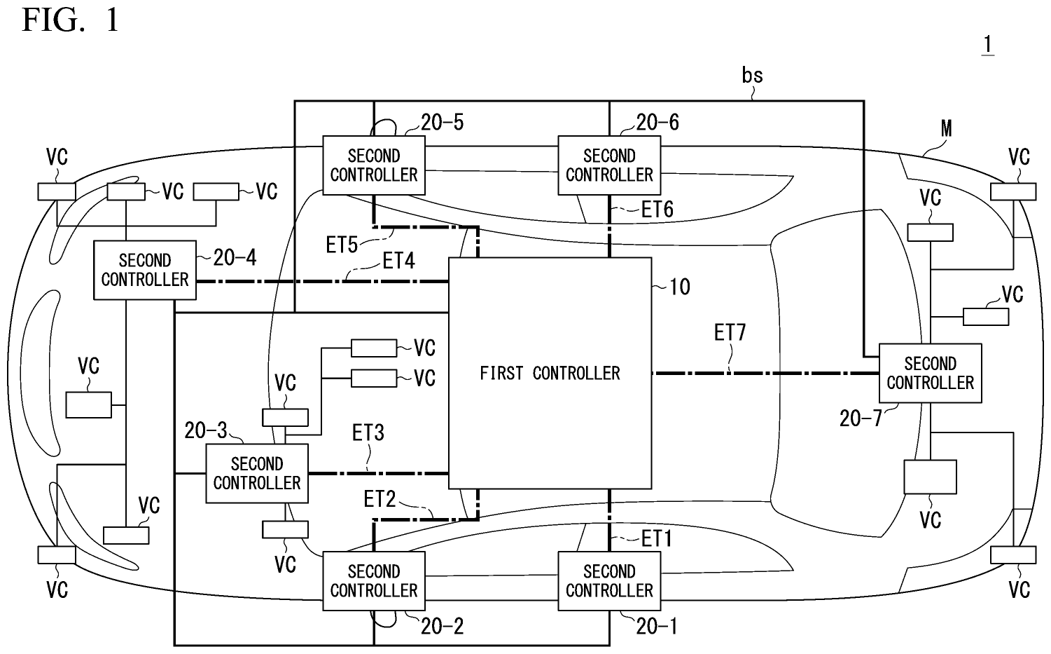

FIG. 1 is a diagram showing an example of a configuration of a vehicle control system 1. The vehicle control system 1 is, for example, a system mounted in a vehicle M. The vehicle control system 1 includes, for example, at least one first controller 10 and a plurality of second controllers 20. One first controller and seven second controllers 20 are shown in the example of FIG. 1 but are merely an example. Numbers following hyphens at the ends of reference signs of the second controllers 20 are identifiers for distinguishing the second controllers 20. These will be simply referred to as second controllers 20 when they are not distinguished. Similarly, numbers following hyphens in hyphenated identifiers of components other than the second controllers 20 indicate that these are components corresponding to the second controllers 20 with the same hyphenated numbers. The first controller 10 and the second controllers 20 are, for example, electronic control units (ECUs) included in the vehicle M. Each second controller 20 may be a processor having a simpler configuration. The first controller 10 transmits, for example, information regarding the operation of each second controller 20 to the second controller 20 via a network. For example, each second controller 20 receives information transmitted by the first controller 10 via a network and controls in-vehicle devices VC included in the vehicle M on the basis of the received information. Details of the network will be described later.

In-vehicle devices VC to be controlled by each second controller 20 are allocated to the second controller 20 in advance. In-vehicle devices VC allocated to the second controller 20 are, for example, those installed near the second controller 20. For example, in-vehicle devices VC installed on the left rear side of the vehicle M are allocated as control targets to a second controller 20-1 on the left rear side of the vehicle M, in-vehicle devices VC installed on the left front side of the vehicle M are allocated as control targets to a second controller 20-2 on the left front side of the vehicle M, in-vehicle devices VC installed at the center of the vehicle M are allocated as control targets to a second controller 20-3 at the center of the vehicle M, in-vehicle devices VC installed on the front of the vehicle M are allocated as control targets to a second controller 20-4 on the front of the vehicle M, in-vehicle devices VC installed on the right front side of the vehicle M are allocated as control targets to a second controller 20-5 on the right front side of the vehicle M, in-vehicle devices VC installed on the right rear side of the vehicle M are allocated as control targets to a second controller 20-6 on the right rear side of the vehicle M, and in-vehicle devices VC installed on the rear of the vehicle M are allocated as control targets to a second controller 20-7 on the rear of the vehicle M.

The first controller 10 and each second controller 20 normally perform communication regarding the operation of the second controller 20 via a first type network. The first type network is, for example, an Ethernet (registered trademark)-based network. Second controllers 20 communicate with each other via a second type network. The second type network is, for example, a CAN with flexible data rate (CAN-FD)-based network. Communication between the second controllers 20 includes, for example, information that is not required to be transmitted to the first controller 10 (for example, information that the first controller 10 needs to involve). The first controller 10 and each second controller 20 perform communication regarding the operation of the second controller 20 via a second type network when an abnormality has occurred.

The above description refers to the case where only the second controllers 20 communicate with each other via a CAN, but the present invention is not limited to this. The first controller 10 may also be connectable to each second controller 20, for example, via a CAN in addition to an Ethernet. The following description refers to the case where the first controller 10 is also connected to a CAN-FD network.

The above description refers to the case where the first type network is an Ethernet and the second type network is a CAN, but the present invention is not limited to this. The first type network and the second type network may be another combination as long as the first type network has a higher payload transmission efficiency than the second type network and the first type network and the second type network are of different communication protocols. The second type network may be a network such as a controller area network (CAN), a local interconnect network (LIN), a FlexRay network, and the like in addition to the CAN-FD.

The above description refers to the case where the first type network is an Ethernet and the second type network is a CAN, but the present invention is not limited to this. The first type network may be a dedicated CAN bus bs between the first controller 10 and the second controllers 20 and the second type networks may be a CAN bus bs that connects the second controllers 20 to each other and connects the second controllers 20 to the first controller 10. In this case, the dedicated CAN bus bs has a higher payload transmission efficiency (for example, a higher transmission speed) than the CAN bus bs that connects the second controllers 20 to each other and connects the second controllers 20 to the first controller 10.

### [Network Configuration]

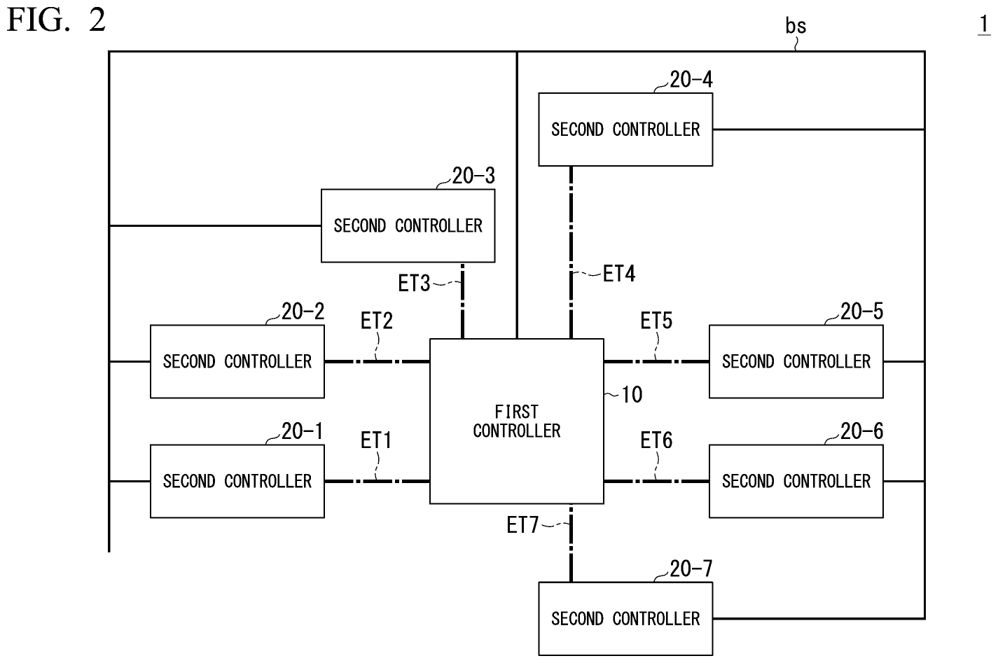

FIG. 2 is a diagram showing an example of a network configuration of the vehicle control system 1. In FIG. 2, the first controller 10 communicates with the second controllers 20 via Ethernets. The first controller 10 communicates with the second controllers 20 via dedicated interface cables (for example, twisted pair (TP) cables or optical communication cables) of Ethernets ET. Hereinafter, it is assumed that the dedicated interface cables are TP cables. For example, the first controller 10 and the second controller 20-1 communicate with each other via a dedicated interface cable of an Ethernet ET1, the first controller 10 and the second controller 20-2 communicate with each other via a dedicated interface cable of an Ethernet ET2, the first controller 10 and the second controller 20-3 communicate with each other via a dedicated interface cable of an Ethernet ET3, the first controller 10 and the second controller 20-4 communicate with each other via a dedicated interface cable of an Ethernet ET4, the first controller 10 and the second controller 20-5 communicate with each other via a dedicated interface cable of an Ethernet ET5, the first controller 10 and the second controller 20-6 communicate with each other via a dedicated interface cable of an Ethernet ET6, and the first controller 10 and the second controller 20-7 communicate with each other via a dedicated interface cable of an Ethernet ET7.

The second controllers 20 communicate with each other via CAN-FD interface cables (for example, TP cables). Hereinafter, the CAN-FD interface cables will be referred to as a CAN bus bs.

### [Configuration of Second Controller 20]

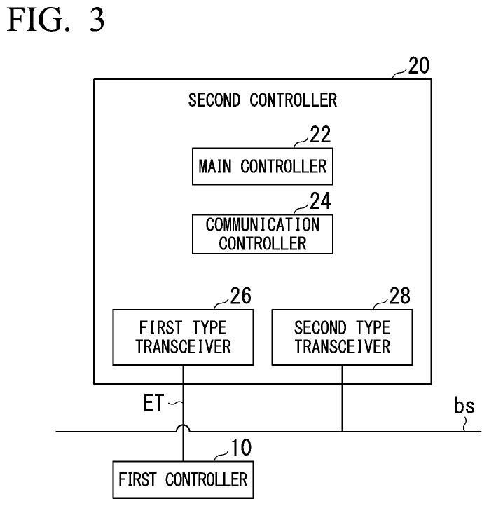

Each second controller 20 will be described below prior to the description of the first controller 10. FIG. 3 is a diagram showing an example of a configuration of each second controller 20. The second controller 20 includes, for example, a main controller 22, a communication controller 24, a first type transceiver 26, and a second type transceiver 28. Each of the main controller 22 and the communication controller 24 is realized, for example, by a hardware processor such as a central processing unit (CPU) executing a program (software). Some or all of these components may be realized by hardware (including circuitry) such as large scale integration (LSI), an application specific integrated circuit (ASIC), a field-programmable gate array (FPGA), or a graphics processing unit (GPU) or may be realized by software and hardware in cooperation. The program may be stored in a storage device (a storage device including a non-transitory storage medium) such as a hard disk drive (HDD) or a flash memory in advance or may be stored in a detachable storage medium (a non-transitory storage medium) such as a DVD or a CD-ROM and then installed by mounting the storage medium in a drive device.

The main controller 22 performs processing for controlling in-vehicle devices VC allocated to each second controller 20 on the basis of an instruction from the first controller 10. The main controller 22 performs processing for air-conditioner airflow control or temperature control if an in-vehicle device VC allocated to the second controller 20 is an air-conditioner and the second controller 20 is an air-conditioner ECU and performs processing for content selection control and volume control if an in-vehicle device VC allocated to the second controller 20 is an audio device and the second controller 20 is an audio ECU. The main controller 22 acquires information that the first controller 10 uses to control the second controller 20 and outputs the acquired information to the communication controller 24. The information that the first controller 10 uses to control the second controller 20 is, for example, detection information obtained by detecting a state of the in-vehicle device VC connected to the second controller 20.

The communication controller 24 performs packet arbitration processing in the Ethernet ET or processing such as trailer check. The communication controller 24 generates an Ethernet frame on the basis of the detection information output from the main controller 22. The communication controller 24 generates, for example, an Ethernet frame including a protocol packet according to an instruction from the main controller 22. The communication controller 24 controls the first type transceiver 26 such that it transmits the generated Ethernet frame to the first controller 10 via the Ethernet ET. The communication controller 24 extracts a data (payload) portion from an Ethernet frame that the first type transceiver 26 has received from the first controller 10 via the Ethernet ET and outputs the extracted data portion to the main controller 22. In this case, the payload portion includes instruction information from the first controller 10 which instructs the second controller 20 to perform an operation.

The communication controller 24 performs arbitration processing in the CAN-FD or processing such as bit stuffing and CRC checking. The communication controller 24 controls the second type transceiver 28 such that it outputs a CAN frame including the CAN-ID of a second controller 20 to which the CAN frame is to be transmitted to the CAN bus bs in accordance with an instruction from the main controller 22. CAN-IDs are information that enables identification of devices connected to the CAN bus bs (the first controller 10 and the second controllers 20 in this case). CAN-IDs are preset for the devices connected to the CAN bus bs. Hereinafter, it is assumed that any device connected to the CAN bus bs recognizes the CAN-IDs of other devices. The communication controller 24 extracts a data portion from a CAN frame that the second type transceiver 28 has received via the CAN bus bs and outputs the extracted data portion to the main controller 22.

A processor constituting the main controller 22 and a processor constituting the communication controller 24 may be the same or may be separate. That is, the main controller 22 and the communication controller 24 may be separate in software or may be separate in hardware.

A dedicated interface cable is connected to the first type transceiver 26. The first type transceiver 26 is configured to pass a signal (data) indicated by a differential voltage to the dedicated interface cable of the Ethernet ET and includes a voltage generator that can generate a differential voltage. The first type transceiver 26 includes a detector that detects a differential voltage and outputs the detected differential voltage to the communication controller 24. Hereinafter, the first type transceiver 26 transmitting information via the Ethernet ET under control of the communication controller 24 will also be referred to as the communication controller 24 transmitting information via the Ethernet ET.

The second type transceiver 28 is connected to the CAN bus bs. The CAN bus bs is configured to transmit a signal (data) by a differential voltage and the second type transceiver 28 includes a voltage generator that can generate a differential voltage state with the differential voltage being near zero (dominant) and a differential voltage state with the differential voltage being a certain voltage or higher (recessive). The second type transceiver 28 includes a detector that detects a differential voltage and outputs the detected differential voltage to the communication controller 24. Hereinafter, the second type transceiver 28 transmitting information via the CAN bus bs under control of the communication controller 24 will also be referred to as the communication controller 24 transmitting information via the CAN bus bs.

### [Configuration of First Controller 10]

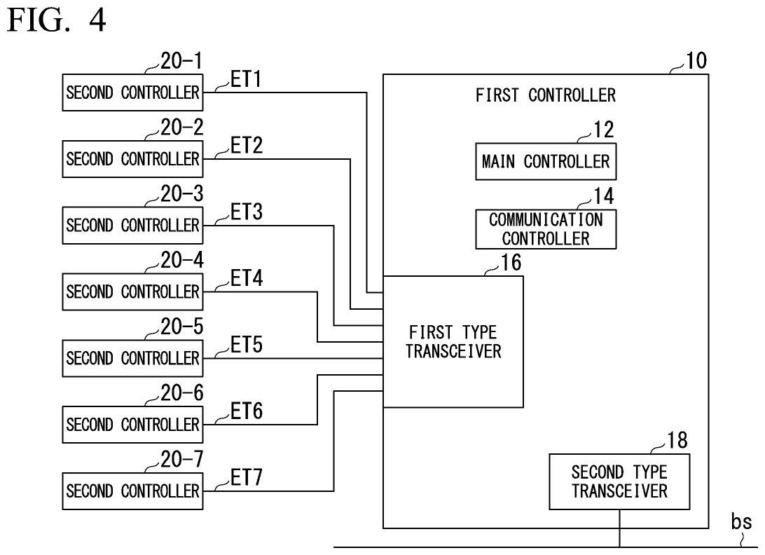

FIG. 4 is a diagram showing an example of a configuration of the first controller 10. The first controller 10 includes, for example, a main controller 12, a communication controller 14, a first type transceiver 16, and a second type transceiver 18. Each of the main controller 12 and the communication controller 14 is realized, for example, by a hardware processor such as a CPU executing a program (software). Some or all of these components may be realized by hardware (including circuitry) such as LSI, an ASIC, an FPGA, or a GPU or may be realized by software and hardware in cooperation. The program may be stored in a storage device (a storage device including a non-transitory storage medium) such as an HDD or a flash memory in advance or may be stored in a detachable storage medium (a non-transitory storage medium) such as a DVD or a CD-ROM and then installed by mounting the storage medium in a drive device.

The main controller 12 performs processing for instructing each second controller 20 to perform control allocated to the second controller 20. The main controller 12 determines an instruction regarding the operation of the second controller 20 on the basis of detection information that the communication controller 14 has received from the second controller 20 via the Ethernet ET. Then, the main controller 12 outputs information indicating the determined instruction (that is, instruction information) to the communication controller 14.

The main controller 12 may also perform processing other than that regarding the operation of the second controller 20 (for example, processing regarding control of an in-vehicle device VC connected to the first controller 10) when the processing has been allocated to the first controller 10.

The communication controller 14 performs packet arbitration processing in the Ethernet ET or processing such as trailer check. The communication controller 14 generates an Ethernet frame on the basis of instruction information output from the main controller 12. The communication controller 14 generates, for example, an Ethernet frame including a packet of a protocol used for communication with a second controller 20 which is a communication destination in accordance with an instruction from the main controller 12. The communication controller 14 controls the first type transceiver 16 such that it transmits the generated Ethernet frame to the second controller 20 via the Ethernet ET. The communication controller 14 extracts a data (payload) portion from an Ethernet frame that the first type transceiver 16 has received from the second controller 20 via the Ethernet ET and outputs the extracted data portion to the main controller 12. In this case, the payload portion includes detection information. Details of a process in which the communication controller 14 transmits the Ethernet frame to the second controller 20 will be described later.

The communication controller 14 performs arbitration processing in the CAN-FD or processing such as bit stuffing and CRC checking. The communication controller 14 controls the second type transceiver 18 such that it outputs a CAN frame including the CAN-ID of a second controller 20 to which the CAN frame is to be transmitted to the CAN bus bs in accordance with an instruction from the main controller 12. The communication controller 14 extracts a data portion from a CAN frame that the second type transceiver 18 has received via the CAN bus bs and outputs the extracted data portion to the main controller 12.

A processor constituting the main controller 12 and a processor constituting the communication controller 14 may be the same or may be separate. That is, the main controller 12 and the communication controller 14 may be separate in software or may be separate in hardware.

The first type transceiver 16 is connected to each of the plurality of second controllers 20 through a dedicated interface cable. The first type transceiver 16 transmits an Ethernet frame to a second controller 20 to which the Ethernet frame is to be transmitted via a dedicated interface cable of the second controller 20 in accordance with an instruction from the communication controller 14. The first type transceiver 16 is configured to pass a signal (data) indicated by a differential voltage to the dedicated interface cable of the Ethernet ET and includes a voltage generator that can generate a differential voltage. The first type transceiver 16 includes a detector that detects a differential voltage and outputs the detected differential voltage to the communication controller 14. The second type transceiver 18 has the same configuration as the second type transceiver 28 and thus a description thereof will be omitted.

Hereinafter, the first type transceiver 16 transmitting information via the Ethernet ET under control of the communication controller 14 will also be referred to as the communication controller 14 transmitting information via the Ethernet ET. Hereinafter, the second type transceiver 18 transmitting information via the CAN bus bs under control of the communication controller 14 will also be referred to as the communication controller 14 transmitting information via the CAN bus bs.

### [Routing Process of Communication Controller 14: in Normal State]

The communication controller 14 performs a routing process of referring to information indicating transmission routes of second controllers 20 which pass through Ethernets ET (hereinafter referred to as a routing table) and determining a transmission route of an Ethernet frame. The communication controller 14 refers to the routing table for a second controller 20 to be controlled and determines a transmission route of the second controller 20. Hereinafter, it is assumed that the communication controller 14 divides Ethernets ET virtually using virtual local area networks (VLANs). Thus, basically, only information regarding the operation of a second controller 20 connected to the Ethernet ET is transmitted to each Ethernet ET.

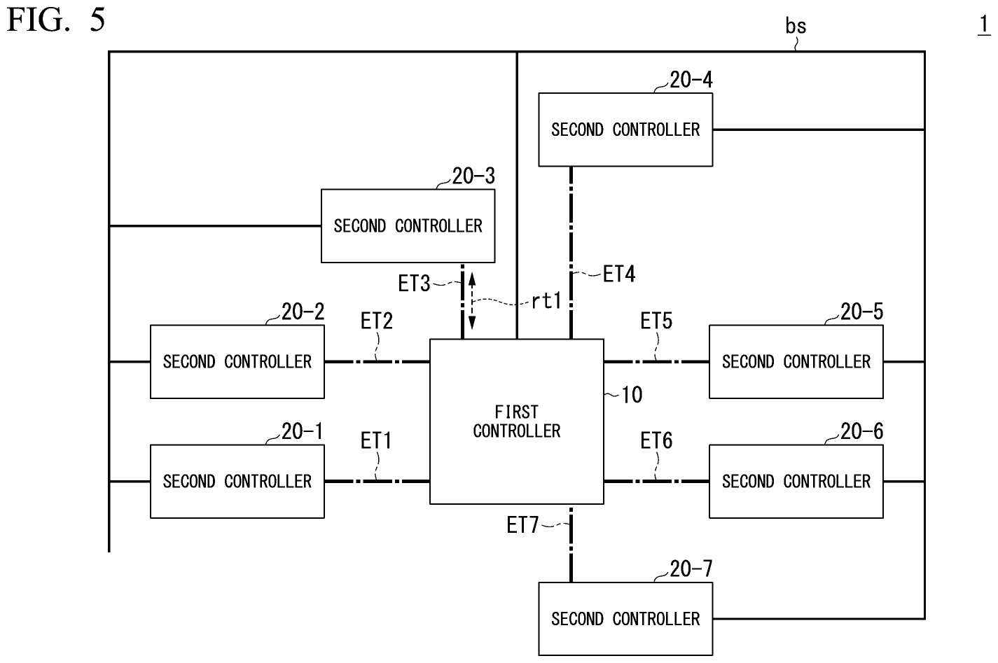

FIG. 5 is a diagram schematically showing communication between the first controller 10 and a second controller 20. For example, when the communication controller 14 transmits information regarding the operation of the second controller 20-3 to the second controller 20-3 on the basis of an instruction from the main controller 12, the communication controller 14 refers to the routing table and determines the Ethernet ET3 among Ethernets ET connected to the first type transceiver 16 as a transmission route rt1. Then, the communication controller 14 causes an Ethernet frame to be transmitted through a port to which a dedicated interface cable of the Ethernet ET3 determined as the transmission route rt1 is connected. The communication controller 14 receives an Ethernet frame that has been transmitted to the first controller 10 from the second controller 20-3. In this manner, the first controller 10 and the second controller 20-3 communicate with each other via the Ethernet ET3.

### [Routing Process of Communication Controller 14: Upon Failure]

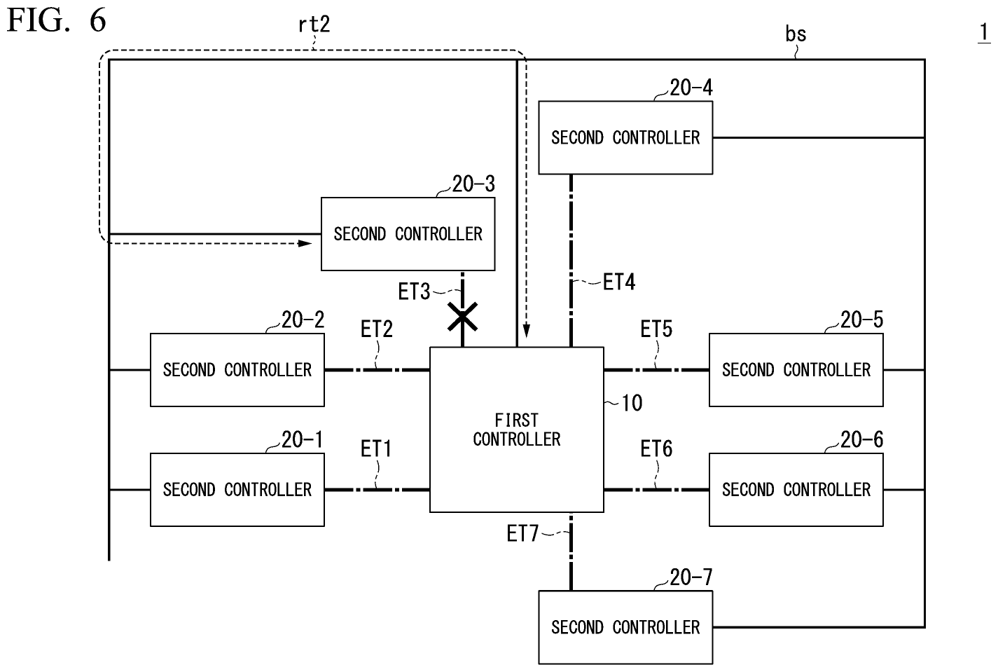

FIG. 6 is a diagram schematically showing communication between the first controller 10 and a second controller 20 when an Ethernet ET therebetween has failed according to the embodiment. Cases where a transmission route between the first controller 10 and a second controller 20 has failed include, for example, the case where communication via the Ethernet ET is not possible (the link is down) because the dedicated interface cable is cut, the communication controller 24 or the first type transceiver 26 included in the second controller 20 is not functioning properly, or a function of the first type transceiver 16 relating to some or all of the second controllers 20 is not functioning properly. Failure of the transmission route between the first controller 10 and the second controller 20 is an example of the “first type network having reached a predetermined state.”

When an Ethernet ET between the first controller 10 and a second controller 20 has failed, the communication controller 14 of the first controller 10 communicates with the failed second controller 20 via the CAN bus bs. The communication controller 14 generates a CAN frame including information (instruction information in this case) that was to be transmitted to the second controller 20 via the Ethernet ET and causes the second type transceiver 18 to transmit the generated CAN frame to the failed second controller 20 (the second controller 20-3 in FIG. 6) via the CAN bus bs. A transmission route rt2 in this case is that passing through the CAN bus bs.

The communication controller 24 of the second controller 20 generates a CAN frame including information (detection information in this case) that was to be transmitted to the first controller 10 via the Ethernet ET and causes the second type transceiver 28 to transmit the generated CAN frame to the first controller 10 via the CAN bus bs. In this manner, the vehicle control system 1 can achieve redundancy of communication between the first controller 10 and each second controller 20 (communication between controllers of the vehicle M) through a simple process when the Ethernet ET between the first controller 10 and the second controller 20 has failed.

### [Operation Flow]

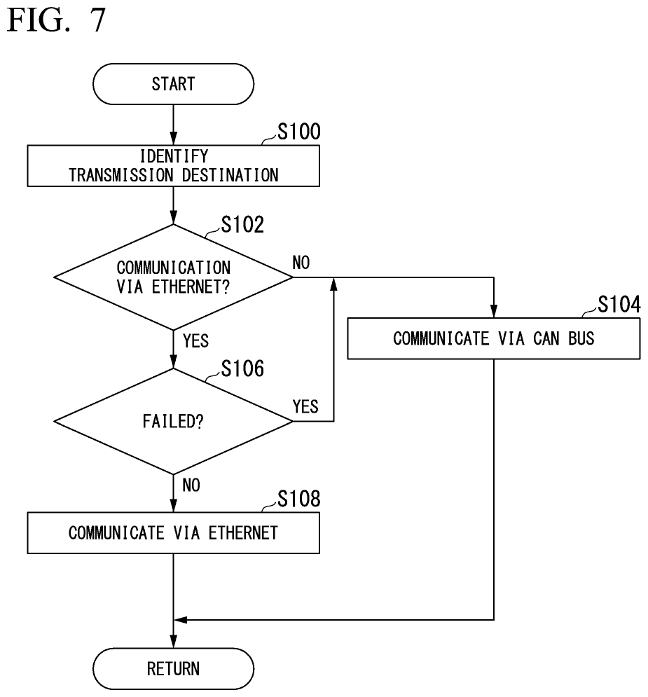

FIG. 7 is a flowchart showing an example of processing of the communication controller 14 and the communication controller 24. Hereinafter, the communication controller 14 and the communication controller 24 are each simply referred to as a “communication controller” when they are not distinguished. First, a communication controller identifies the transmission destination of information (detection information or instruction information) (step S100). The communication controller determines whether or not communication with the identified transmission destination is communication via an Ethernet ET (step S102). The communication controller 14 determines that the communication with the identified transmission destination is communication via an Ethernet ET when the identified transmission destination is a second controller 20 and the communication controller 24 determines that the communication with the identified transmission destination is communication via an Ethernet ET when the identified transmission destination is the first controller 10. Upon determining that the communication with the identified transmission destination is not communication via an Ethernet ET, the communication controller transmits information to the identified transmission destination via the CAN bus bs (step S104).

Upon determining that the communication with the identified transmission destination is communication via an Ethernet ET, the communication controller determines whether or not the Ethernet ET between the communication controller and the transmission destination has failed (step S106). Upon determining that the Ethernet ET has not failed, the communication controller determines the Ethernet ET as a transmission route and causes an Ethernet frame including information to be transmitted via the determined Ethernet ET (step S108). For example, the communication controller 14 causes the first type transceiver 16 to transmit an Ethernet frame including instruction information to the second controller 20 via the Ethernet ET and the communication controller 24 causes the first type transceiver 26 to transmit an Ethernet frame including detection information to the first controller 10 via the Ethernet ET.

Upon determining that the Ethernet ET has failed, the communication controller decides to transmit information via the CAN bus bs and the process proceeds to step S104. In this case, the communication controller 14 generates a CAN frame including information (instruction information in this case) that was to be transmitted to the second controller 20 via the Ethernet ET and causes the second type transceiver 18 to transmit the generated CAN frame to the failed second controller 20 (the second controller 20-3 in FIG. 6) via the CAN bus bs. The communication controller 24 generates a CAN frame including information (detection information in this case) that was to be transmitted to the first controller 10 via the Ethernet ET and causes the second type transceiver 28 to transmit the generated CAN frame to the first controller 10 via the CAN bus bs.

### [Summary of Embodiment]

In the vehicle control system 1 according to the present embodiment, basically, the first controller 10 communicates with each second controller 20 via an Ethernet ET while the second controllers 20 communicate with each other via the CAN bus bs, but the first controller 10 communicates with the second controller 20 via the CAN bus bs when the Ethernet ET has failed as described above, thereby achieving redundancy of communication between the first controller 10 and each second controller 20 (communication between controllers of the vehicle M).

For example, providing redundancy merely of Ethernets ET between the first controller 10 and the second controllers 20 may incur costs to add Ethernets ET. On the other hand, the vehicle control system 1 of the present embodiment can achieve redundancy of communication between the first controller 10 and each second controller 20 while limiting cost increases.

In this case, when the first controller 10 transmits the same data to a plurality of second controllers 20, the first controller 10 can broadcast the same data to the plurality of second controllers 20 via the CAN bus bs. Thus, even when an Ethernet ET between the first controller 10 and a second controller 20 has failed, the first controller 10 and the second controller 20 can transmit information via the CAN bus bs through a simple process while achieving redundancy of communication between the first controller 10 and the second controller 20.

### <Modification>

A modification of the above embodiment will be described below with reference to the drawings. In the above embodiment, when an Ethernet ET between the first controller 10 and a second controller 20 has failed, the first controller 10 and the failed second controller 20 communicate via the CAN bus bs. In the modification, when an Ethernet ET between the first controller 10 and a second controller 20 has failed, a second controller 20 other than the failed second controller 20 relays communication between the first controller 10 and the failed second controller 20. The same components as those of the above embodiment are denoted by the same reference signs and a description thereof will be omitted.

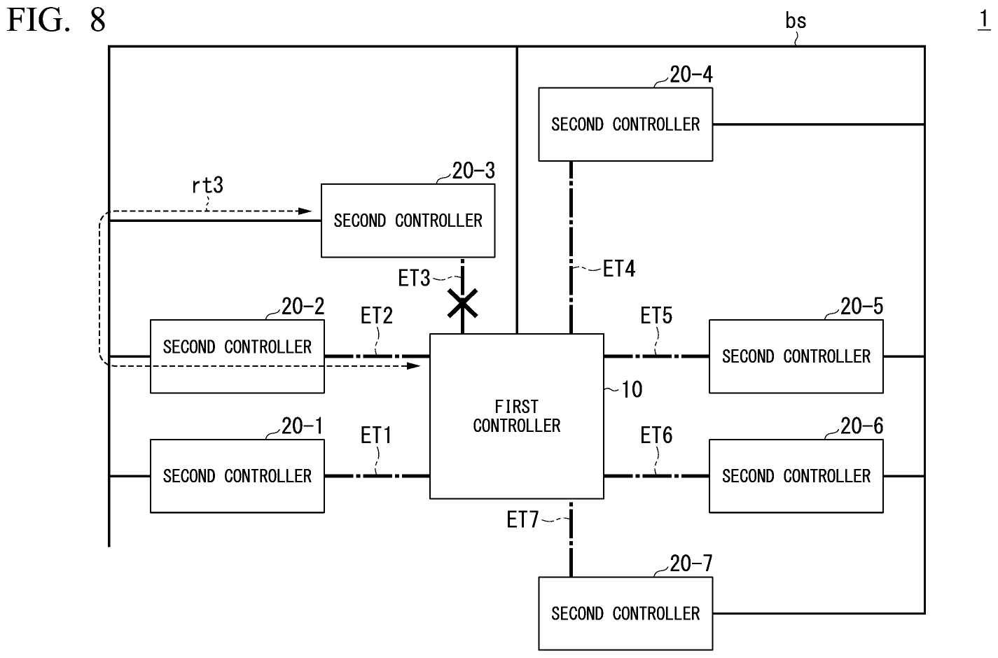

FIG. 8 is a diagram schematically showing communication between the first controller 10 and a second controller 20 when an Ethernet ET therebetween has failed according to the modification. The communication controller 14 of the modification determines whether or not a transmission route between the first controller 10 and each second controller 20 has failed by transmitting a signal for network communication check to each second controller 20 at predetermined time intervals. The communication controller 14 determines that an Ethernet ET between the first controller 10 and a second controller 20 has not failed if there is a response to the signal from the second controller 20 and determines that the Ethernet ET between the first controller 10 and the second controller 20 has failed if there is no response. In the situation of FIG. 8, the Ethernet ET3 has failed and thus the first controller 10 determines that the transmission route rt1 of the Ethernet ET3 has failed because the first controller 10 has transmitted a signal for network communication check to the second controller 20-3 but has not received a response to the signal from the second controller 20-3.

The communication controller 14 may also determine whether or not the transmission route between the first controller 10 and the second controller 20 has failed by checking the link state of a physical interface (for example, a network interface card (NIC)) while monitoring the state of the Ethernet ET by transmitting a signal for network communication check.

The above description refers to the case where the communication controller 14 monitors the state of the Ethernet ET. However, the present invention is not limited to this and the communication controller 24 may monitor the state of the Ethernet ET. A process of monitoring the state of Ethernet ET by the communication controller 24 is the same as the process of monitoring the state of Ethernet ET by the communication controller 14 described above and thus a description thereof will be omitted. Hereinafter, it is assumed that the communication controller 14 and the communication controller 24 both monitor the state of the Ethernet ET.

When the Ethernet ET has failed, the communication controller 14 or the communication controller 24 performs a routing process for communicating with a second controller 20 other than the failed second controller 20 via an Ethernet ET and allowing the second controller 20 other than the failed second controller 20 to communicate with the failed second controller 20 via the CAN bus bs. This allows the first controller 10 and the failed second controller 20 to communicate with each other.

In FIG. 8, the communication controller 14 or the communication controller 24 determines a transmission route rt3 passing through the Ethernet ET2, the second controller 20-2, and the CAN bus bs as the transmission route in the routing process. In this case, the communication controller 14 generates an Ethernet frame including the CAN-ID of the failed second controller 20-3 and transmits the generated Ethernet frame to the second controller 20 other than the failed second controller 20 (to the second controller 20-2 in FIG. 8) via the Ethernet ET2.

The communication controller 24 of the second controller 20-2 which relays communication protocol-converts the Ethernet frame received from the first controller 10 into a CAN frame. Based on the CAN-ID included in the Ethernet frame, the communication controller 24 transmits the CAN frame obtained through protocol conversion to the second controller 20 of the CAN-ID (the second controller 20-3 whose transmission route has failed in this case) via the CAN bus bs.

The communication controller 24 of the failed second controller 20-3 generates a CAN frame including information which is to be transmitted to the first controller 10 via the Ethernet ET (for example, detection information) and transmits the generated CAN frame to the second controller 20 which relays communication with the first controller 10 (the second controller 20-2 in this case) via the CAN bus bs. A communication controller 24 of the second controller 20-2 protocol-converts the CAN frame, which it has received from the failed second controller 20-3 via the CAN bus bs, into an Ethernet frame and transmits the Ethernet frame to the first controller 10 via the Ethernet ET2. In this manner, the vehicle control system 1 allows the first controller 10 and each second controller 20 to communicate with each other even when an Ethernet ET between the first controller 10 and the second controller 20 has failed.

The above description refers to the case where the second controller 20-2 relays communication between the first controller 10 and the failed second controller 20-3, but the present invention is not limited to this. Any second controller 20 other than the failed second controller 20-3 may relay communication between the first controller 10 and the failed second controller 20-3.

### [Summary of Modification]

As described above, in the vehicle control system 1 of the modification, the first controller 10 communicates with each second controller 20 via an Ethernet ET and the second controllers 20 communicate with each other via the CAN bus bs, whereby redundancy of communication between the first controller 10 and each second controller 20 (communication between controllers of the vehicle M) is achieved such that communication is possible between the first controller 10 and a second controller 20 even when an Ethernet ET between the first controller 10 and the second controller 20 has failed.

### [About Fallback Control]

When an Ethernet ET between the first controller 10 and a second controller 20 has failed, at least one of the first controller 10 and the second controller 20 may perform simpler control than before the Ethernet ET has failed (for example, fallback control). In this case, when the communication controller 14 has determined that any of Ethernets ET between the first controller 10 and each second controller 20 have failed, the main controller 12 transmits instruction information instructing to perform fallback control to the each second controller 20. When the communication controller 24 has determined that the Ethernet ET has failed or when the second controller 20 has received instruction information instructing to perform fallback control from the first controller 10, the second controller 20 performs fallback control of its own processing or in-vehicle devices VC.

Although modes for carrying out the present invention have been described above by way of embodiments, the present invention is not limited to these embodiments at all and various modifications and substitutions can be made without departing from the gist of the present invention.

What is claimed is:

1. A vehicle control system comprising:
a first controller mounted in a vehicle; and
a plurality of second controllers mounted in the vehicle, each of the plurality of second controllers being configured to control at least one in-vehicle device allocated to the second controller among a plurality of in-vehicle devices mounted in the vehicle,
wherein the first controller is configured to perform communication with each of the plurality of second controllers via a first type network, the communication regarding an operation of the second controller, and
at least the plurality of second controllers are configured to be able to communicate with each other via a second type network different from the first type network.

2. The vehicle control system according to claim 1, wherein the first type network has a higher payload transmission efficiency than the second type network.

3. The vehicle control system according to claim 1, wherein the first controller is configured to, when a first type network between the first controller and a specific one of the plurality of second controllers has reached a predetermined state, communicate with a second controller other than the specific second controller via a first type network and communicate with the specific second controller via the second controller other than the specific second controller.

4. The vehicle control system according to claim 1, wherein the first controller is configured to be also connectable to the second type network and, when the first type network has reached a predetermined state, communicate with the second controller connected to the first type network that has reached the predetermined state via the second type network.

5. The vehicle control system according to claim 1, wherein at least one of the first controller and the second controllers is configured to, when the first type network has reached a predetermined state, perform simpler control than that before the first type network reached the predetermined state.

6. The vehicle control system according to claim 1, wherein the first type network and the second type network are networks of different communication protocols.

7. The vehicle control system according to claim 1, wherein the first type network is an Ethernet-based network and the second type network is a controller area network (CAN)-based network.

8. A vehicle control method for a computer including a first controller mounted in a vehicle and a plurality of second controllers mounted in the vehicle, each of the plurality of second controllers being configured to control at least one in-vehicle device allocated to the second controller among a plurality of in-vehicle devices mounted in the vehicle, the vehicle control method comprising:
the computer causing the first controller to perform communication with each of the plurality of second controllers via a first type network, the communication regarding an operation of the second controller, and
causing at least the plurality of second controllers to be able to communicate with each other via a second type network different from the first type network.

9. A computer-readable non-temporary storage medium storing a program for a computer including a first controller mounted in a vehicle and a plurality of second controllers mounted in the vehicle, each of the plurality of second controllers being configured to control at least one in-vehicle device allocated to the second controller among a plurality of in-vehicle devices mounted in the vehicle, the program allowing the computer to:
cause the first controller to perform communication with each of the plurality of second controllers via a first type network, the communication regarding an operation of the second controller, and
cause at least the plurality of second controllers to be able to communicate with each other via a second type network different from the first type network.
